(19) United States
(12) Patent Application Publication
(10) Pub. No.: US 2020/0349111 A1
(43) Pub. Date: Nov. 5, 2020

(54) METHOD, DEVICE AND COMPUTER PROGRAM PRODUCT FOR CREATING INDEX FOR STREAM STORAGE

(71) Applicant: EMC IP Holding Company LLC, Hopkinton, MA (US)

(72) Inventors: Jeff Wu, Shanghai (CN); Kevin Kaihao Zhao, Shanghai (CN)

(21) Appl. No.: 16/557,952

(22) Filed: Aug. 30, 2019

(30) Foreign Application Priority Data
Apr. 30, 2019 (CN) 201910360045.2

(51) Int. Cl. G06F 16/13; G06F 16/953

(52) U.S. Cl. CPC G06F 16/13; G06F 16/953

(57) ABSTRACT

An index for stream storage is created. For example, at least one index segment is created for a stored stream and an index file is created for an event in the stream in one of the at least one index segment to map to the event.

### RELATED APPLICATION

The present application claims the benefit of priority to Chinese Patent Application No. 201910360045.2, filed on Apr. 30, 2019, which application is hereby incorporated into the present application by reference herein in its entirety.

### FIELD

Embodiments of the present disclosure generally relate to computer technologies, and more specifically, to a method, a device and a computer program product for creating an index for stream storage.

### BACKGROUND

Stream storage is a novel storage method, which provides a new storage abstraction - a stream—for storing continuous and unbounded data. For example, the stream is a durable, elastic, append-only and unbounded sequence of bytes that has good performance and strong consistency. Currently, a conventional search system only supports an index and a search on block storage, file system storage or object storage and does not support a search on stream storage. Despite of an existence of stream searches, an index created thereon are also based on block storage, a file system or an object storage.

### SUMMARY

In general, embodiments of the present disclosure provide a method, a device and a computer program product for creating an index for stream storage.

In a first aspect, embodiments of the present disclosure provide a method of creating an index for stream storage. The method comprises: creating at least one index segment for a stored stream; and creating, for an event in the stream, an index file in one of the at least one index segment, to map to the event.

In a second aspect, embodiments of the present disclosure provide a device for creating an index for stream storage. The device comprises a processor and a memory having computer-executable instructions stored thereon. The computer-executable instructions, when executed by a processor, cause a device to perform actions comprising: creating at least one index segment for a stored stream; and creating, for an event in the stream, an index file in one of the at least one index segment, to map to the event.

In a third aspect, embodiments of the present disclosure provide a computer program product which is tangibly stored on a non-transitory computer-readable medium and comprises machine-executable instructions. The machine-executable instructions, when executed, cause a machine to perform the method in accordance with the first aspect.

It should be appreciated that the contents described in the Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description with reference to the accompanying drawings, the above and other features, advantages and aspects of every embodiment of the present disclosure will become more apparent. In the drawings, same or similar reference signs represent same or similar elements, where:

FIG. 1 illustrates a conventional search approach based on block storage and file system storage;

FIG. 2 illustrates a conventional approach of stream search;

FIG. 3 illustrates an example search system in which embodiments of the present disclosure can be implemented;

FIGS. 4A and 4B illustrate example formats of a stream in accordance with some embodiments of the present disclosure;

FIG. 5 illustrates a flowchart of an example method of creating an index for stream storage in accordance with some embodiments of the present disclosure;

FIG. 6 illustrates an example format of an index for the stream storage in accordance with some embodiments of the present disclosure;

FIG. 7 illustrates an example mapping relation between the index and streams in accordance with some embodiments of the present disclosure;

FIG. 8 illustrates an example process of mapping the index to streams in accordance with some embodiments of the present disclosure; and

FIG. 9 illustrates a block diagram of a device suitable for implementing embodiments of the present disclosure.

### DETAILED DESCRIPTION OF EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. Rather, the embodiments are provided to understand the present disclosure in a more thorough and complete way. It should be appreciated that drawings and embodiments of the present disclosure are provided only for purpose of examples rather than limiting protection scope of the present disclosure.

The term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” Definitions related to other terms will be described in the following description.

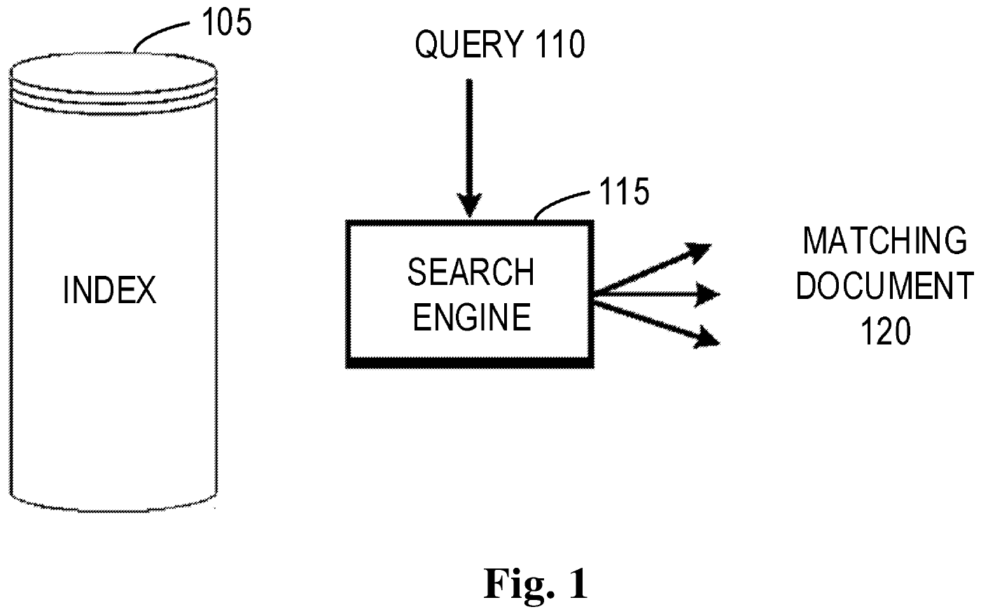

A conventional search approach is built on the block storage and the file system storage. FIG. 1 illustrates a conventional search approach based on the block storage and the file system storage. As shown in FIG. 1, in this search approach, an index 105, such as an inverted index, may be created for data in a form of a document. After receiving a query 110, a search engine 115 finds a matching document 120 with the created index 105. Since the index 105 indexes a document, it is quick to query the document, but a process of building the index is quite slow. Besides, this search system is typically implemented in a file system directory structure and file layout and enables searches on the block storage and the file system storage, without the support of a search on the stream storage.

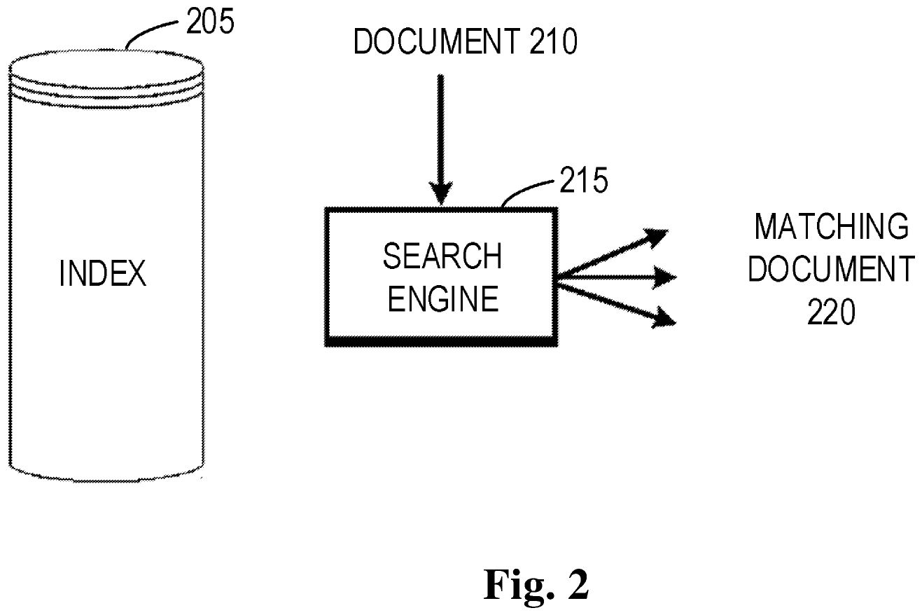

Another search approach is a stream search, in which an index is also built on the basis of the block storage and file system storage. FIG. 2 illustrates a conventional approach of the stream search. This approach builds an index 205 for a query approach. A stream of a document 210 passes through a search engine 215 during a search to find a matching query 220. However, this approach does not enable a search on the stream storage either.

Embodiments of the present disclosure provide a mechanism of creating an index for stream storage to support the search on the stream storage. According to this mechanism, at least one index segment is created for one stored data stream, and one index file is created in one index segment for one event in the stream, to map to the event. The stored stream may be searched with this index, to find the matching event or data. In this way, an index may be created for a dynamic, distributed and real-time updated stream, so as to enable a search and a query for stream data.

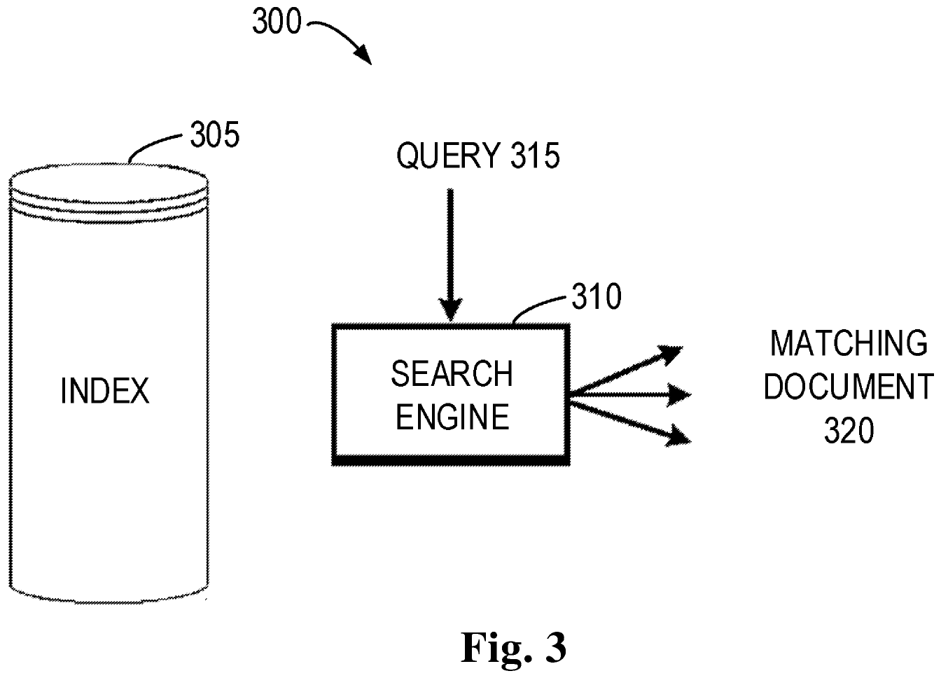

FIG. 3 illustrates an example search system 300 in which embodiments of the present disclosure can be implemented.

In the search system 300, an index 305 is created for various types of information stored in a stream storage system (not shown). The information may include, for example, data in a form of a document, a deleted file, metadata and the like. The information may be stored in the stream storage system in a form of stream.

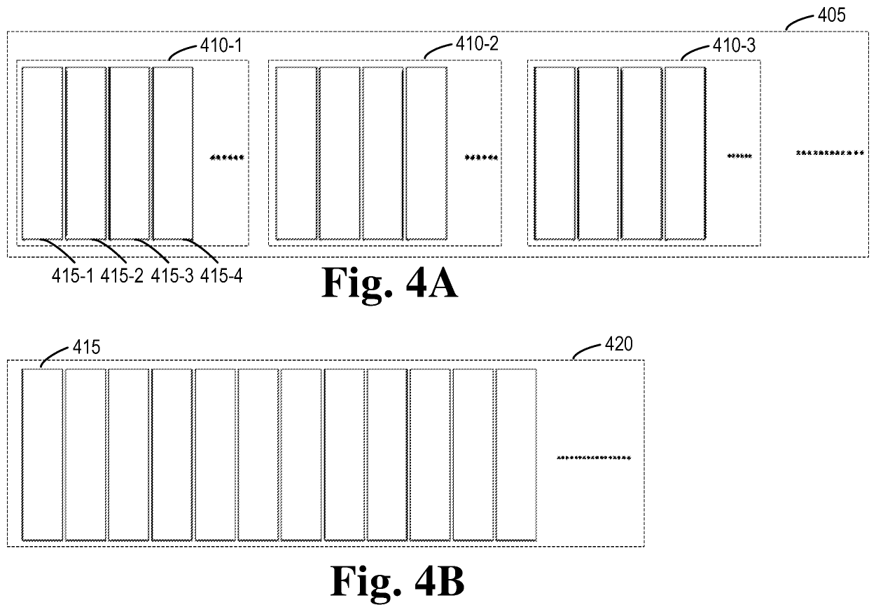

For example, a stream is a durable, elastic, append-only and unbounded sequence of bytes. FIGS. 4A and 4B illustrate example formats of streams. In the example shown in FIG. 4A, a stream 405 includes a plurality of segments 410-1, 410-2, 410-3 . . . , and these segments may be collectively or individually referred to as segment 410. New segments 410 may be added into the stream 405 as new information is added into the stream storage system. Each segment (e.g., the segment 410-1) includes a plurality of events, such as events 415-1, 415-2, 415-3 . . . , and these events are collectively or individually known as event 415. An event 415, for example, is a set of bytes in the stream 405. The stream demonstrated in FIG. 4B is an example implementation of the stream 405 in FIG. 4A and is referred to as a byte stream 420. The byte stream 420 only includes one segment and all information is stored in one segment 410 in a form of an event 415.

It should be appreciated that the stream storage forms shown in FIGS. 4A and 4B are only for purpose of illustration rather than limiting the scope of the present disclosure. Any suitable stream storage manners already known or to be developed can be used here and the scope of the present disclosure is not limited in this regard.

The search system 300 shown in FIG. 3 creates an index 305 for the event 415 in the stream 405. Thus, the created index 305 is based on the stream storage. The index 305 may be stored, for example, in a computing device (not shown) via any suitable manners. Examples of the computing device include, but not limited to: a personal computer (PC), a laptop computer, a tablet computer, a personal digital assistant (PDA), a blade, and the like.

The search system 300 also includes a search engine 310, which may be implemented in a computing device by means of software or combinations of software with hardware or firmware. Users can query information of the stream storage with the search engine 310. For example, in response to a query 315 for a document, from the users, the search engine 310 may search the stored documents to determine a document 320 matching with the query 315 and return the matching document 320. Therefore, the stored stream may be searched and queried with the search system 300. In this way, the search engine 315 may use the index 305 to implement the searches and queries of the event 415 in the stream 405.

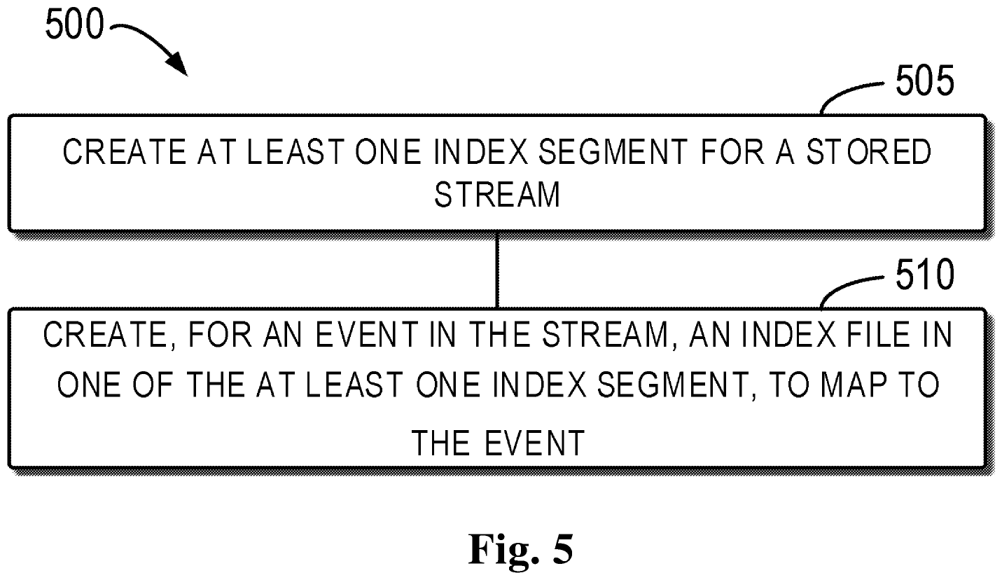

FIG. 5 illustrates a flowchart of an example method 500 of creating an index for stream storage in accordance with some embodiments of the present disclosure. The method 500 may be performed, in the search system 300 shown by FIG. 3, with respect to the streams shown in FIGS. 4A and 4B. For the purpose of discussions, the method 500 will be described below with reference to FIG. 4.

As shown in FIG. 5, at least one index segment is created for a stored stream 405 at block 505. In some embodiments, the stream 405 may include a plurality of segments 410 as shown in FIG. 4A. Accordingly, a plurality of index segments may be created for these segments 410, where each of the plurality of index segments is mapped to the respective segment 410 in the stream 405. In some other embodiments, the stream 405 includes only one segment 410, such as the byte stream 420 shown in FIG. 4B. In this case, only one index segment may be created accordingly.

At block 510, an index file is created, for the event 415 in the stream 405, in one of the at least one index segment, to map to the event 415. For example, in the embodiment that the stream 405 includes a plurality of segments 410, an index segment, which is mapped to the segment 410 including the event 415, is determined first from a plurality of index segments and a corresponding index file is then created in the determined index segment, to map to the event 415.

In some embodiments, if new information is added, a new event 415 may be appended into the stream 405 to write new information. In response to appending the new event into the stream 405, a new index file is added into a corresponding index segment, to map to a new event 415.

The stream 405 may include a metadata stream, a deleted file stream and/or a data stream. The metadata stream is used for storing metadata, which may be global metadata or cloud data. The deleted file stream is used for storing deleted files. The data stream is used for storing data.

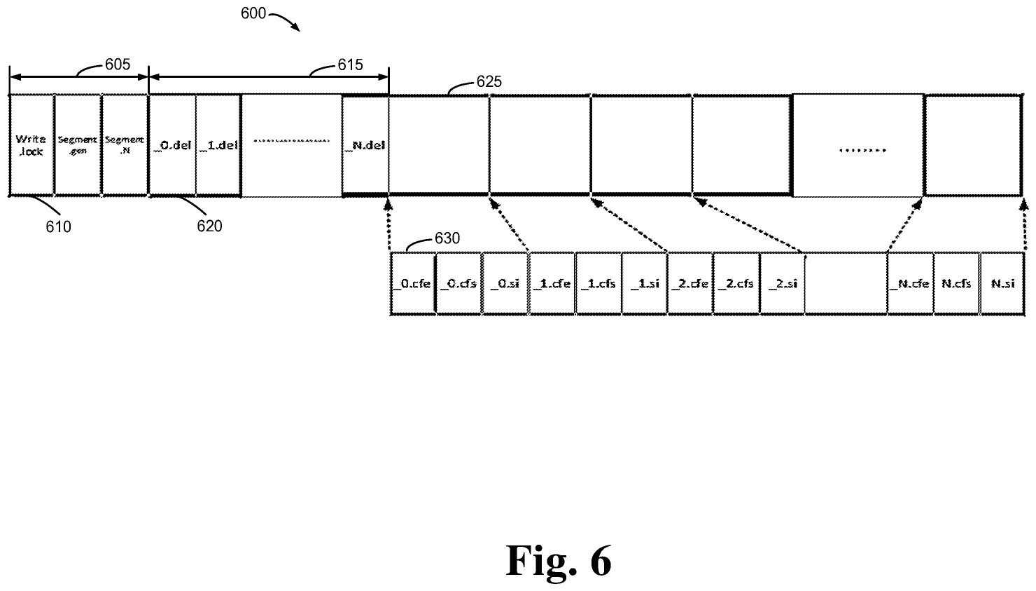

FIG. 6 illustrates an example format of an index 600 for stream storage in accordance with some embodiments of the present disclosure.

As shown in FIG. 6, the index 600 for stream storage includes an index segment 605 for a metadata stream in this example. The index segment 605 includes a plurality of index files 610 for metadata and each of the plurality of index files 610 is mapped to one event in the metadata stream. The index 600 also includes an index segment 615 for the deleted file stream, where index segment 615 includes a plurality of index files 620 for deleted files, where each of the plurality of index files 620 is mapped to one event in the deleted file stream.

Moreover, the index 600 includes a plurality of index segments 625-1, . . . , 625-X (X being any appropriate positive integer greater than N) for the data stream, where the index segments are collectively or individually known as index segment 625 for the data stream. One index segment 625 includes a plurality of index segments 630 for the data and each of the plurality of index segments 630 is mapped to one event in the data stream. The index 600 may be mapped into respective streams through a certain manner, to implement index and search on the stream storage.

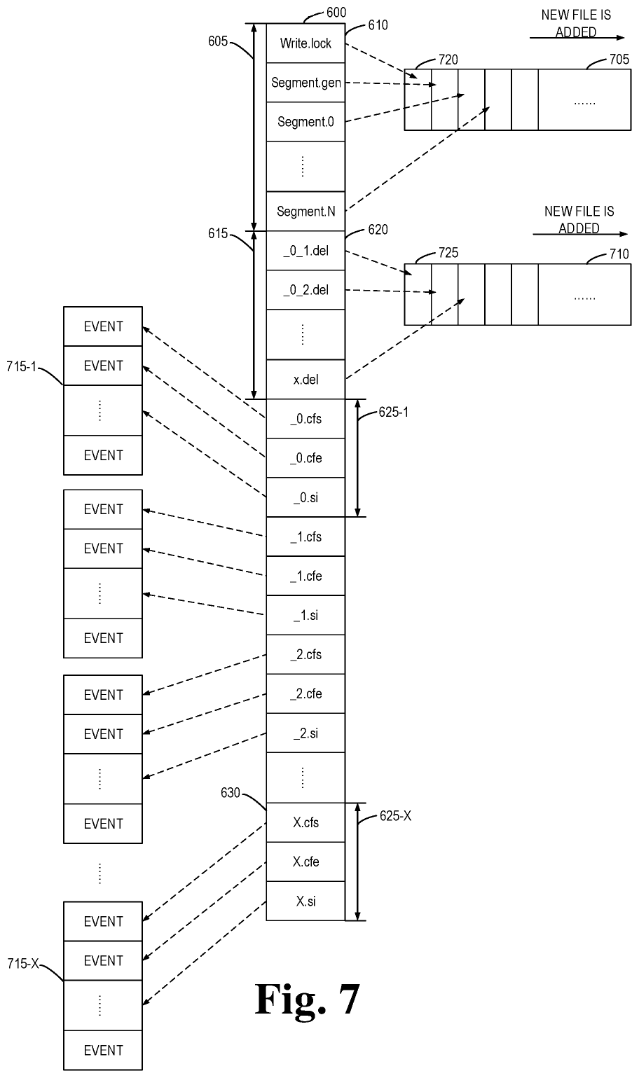

FIG. 7 illustrates an example mapping relation between the index 600 and streams in accordance with some embodiments of the present disclosure.

In this example, the stream 405 includes three types of streams: a metadata stream 705, a deleted file stream 710 and a plurality of data streams 715-1, . . . ,715-X. The index segment 605 for the metadata stream is mapped to the metadata stream 705, where each index file 610 for the metadata is mapped to one event 720 in the metadata stream 705. If a new file is incoming, an additional new event 720 is appended into the metadata stream 705 for writing the new file. Accordingly, a new index file 610 may be added into the index segment 605 for the metadata stream.

The index segment 615 for the deleted file stream is mapped to the deleted file stream 710, where each index file 620 for the deleted file is mapped to one event 725 in the deleted file stream 710. Likewise, if a new deleted file is added, the file is written into the new event 725 and a new index file 620 is added into the corresponding index segment 615.

As shown in FIG. 7, each data stream 715 includes one segment only. Accordingly, each index segment 625-1, . . . , or 625-X for the data stream is mapped to one data stream 715-1, . . . , or 715-X. One index file 630 in each index segment 625 is mapped to a corresponding event 730 in the corresponding data stream 715. In some embodiments, if two or more data streams 715 are combined into one stream, the corresponding index segments 625 may be combined into one index segment.

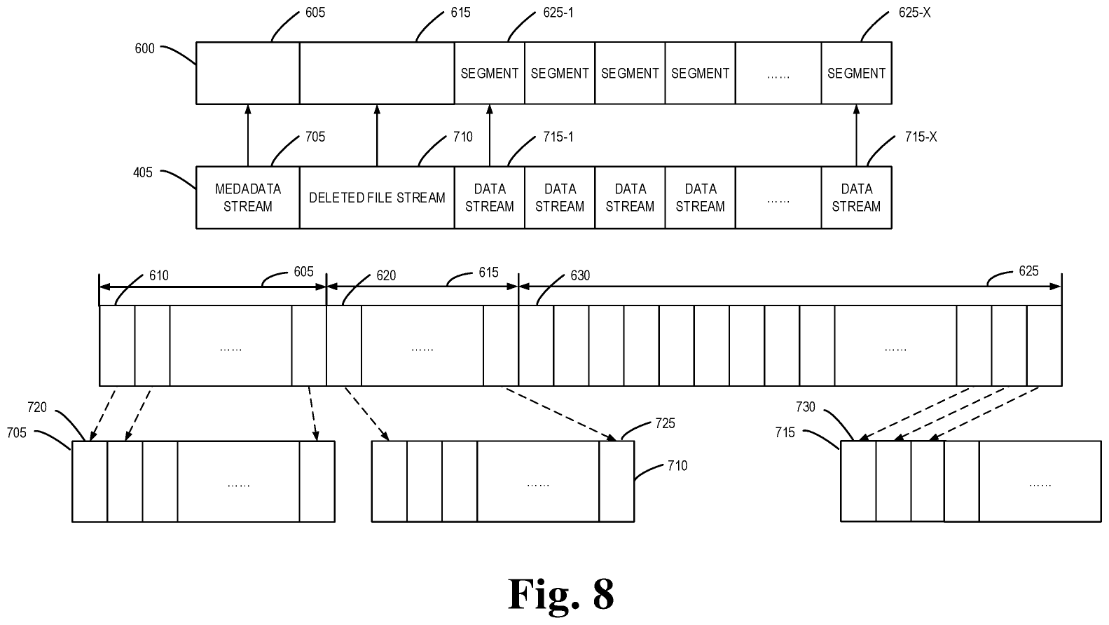

FIG. 8 illustrates an example process of mapping the index 600 to a metadata stream 705, a deleted file stream 710 and data streams 715 in accordance with some embodiments of the present disclosure.

As shown in FIG. 8, in the index 600, the index segment 605 for the metadata stream is mapped to the metadata stream 705 and the index segment 615 for the deleted file stream is mapped to the deleted file stream 710 while the index segments 625-1, . . . , 625-X for the data streams are mapped to the data streams 715-1, . . . , 715-X.

In the index segment 605 for the metadata stream, one index file 610 for the metadata is mapped to one event 720 in the metadata stream 705. In the index segment 615 for the deleted file stream, one index file 620 for the deleted file is mapped to one event 725 in the deleted file stream 710. In the index segment 625 for the data stream, one index file 630 for the data is mapped to one event 730 in the data stream 715.

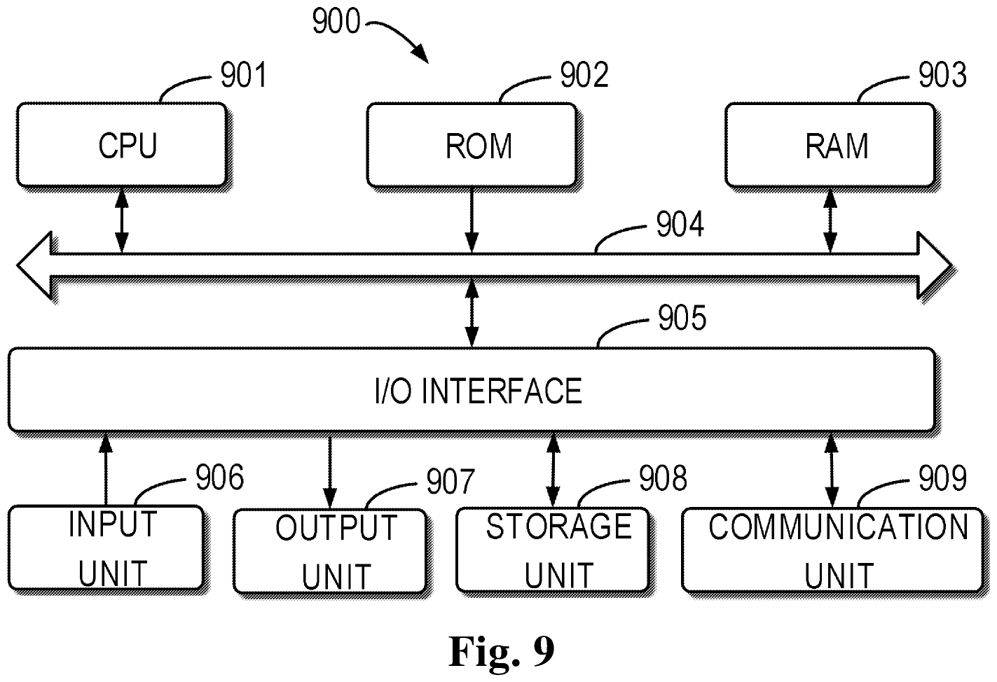

FIG. 9 illustrates a schematic block diagram of a device 900 suitable for implementing embodiments of the present disclosure. As shown, the device 900 includes a controller or a processor, or known as a central process unit (CPU) 901, which can execute various suitable actions and processing based on the programs stored in the read-only memory (ROM) 902 and/or the random-access memory (RAM) 903. The ROM 902 and/or the RAM 903 may store all kinds of programs and data required by the operations of the device 900. The CPU 901, ROM 902 and RAM 903 are connected to each other via a bus 904. Particularly, the device 900 also includes one or more dedicated processing units (not shown) and the dedicated processing units also can be connected to the bus 904.

The input/output (I/O) interface 905 is also connected to the bus 904. A plurality of components in the device 900 is connected to the I/O interface 905, including: an input unit 906, such as a keyboard, a mouse and the like; an output unit 907, e.g., various kinds of displays and loudspeakers etc.; a storage unit 908, such as a disk and an optical disk etc.; and a communication unit 909, such as a network card, a modem, a wireless transceiver and the like. The communication unit 909 allows the device 900 to exchange information/data with other devices via the computer network, such as Internet, and/or various telecommunication networks. In particular, the communication unit 909 supports the communications with the client or other devices in the embodiments of the present disclosure.

In some embodiments, the CPU 901 may be configured to execute various procedures and processing described above, e.g., the method 500. For example, in some embodiments, the method 500 may be implemented as a computer software program tangibly included in the computer-readable medium, e.g., the storage unit 908. In some embodiments, the computer program may be partially or fully loaded and/or mounted to the device 900 via the ROM 902 and/or communication unit 909. When the computer program is loaded to the RAM 903 and executed by the CPU 901, one or more steps of the above method 500 can be implemented. Alternatively, in other embodiments, the CPU 901 also may be configured to implement the above process/method in any other appropriate ways.

Particularly, in accordance with embodiments of the present disclosure, the process described above with reference to FIGS. 1 to 9 may be implemented as the computer program product, which may be tangibly stored on a non-transitory computer-readable storage medium and include computer-executable instructions, the instructions, when executed, causing the device to implement respective aspects according to the present disclosure.

The computer-readable storage medium may be a tangible apparatus that stores instructions utilized by the instruction executing apparatuses. The computer-readable storage medium may include, but not limited to, such as an electrical storage device, a magnetic storage device, an optical storage device, an electromagnetic storage device, a semiconductor storage device or any appropriate combinations of the above. More concrete examples of the computer-readable storage medium (non-exhaustive list) include: a portable computer disk, a hard disk, a random-access memory (RAM), a read-only memory (ROM), an erasable programmable read-only memory (EPROM or flash), a static random-access memory (SRAM), a portable compact disk read-only memory (CD-ROM), a digital versatile disk (DVD), a memory stick, a floppy disk, mechanical coding devices, a punched card stored with instructions thereon, or a projection in a slot, and any appropriate combinations of the above. The computer-readable storage medium utilized herein is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, where the programming languages consist of object-oriented programming languages, such as Java, Smalltalk, C++ and the like, and conventional procedural programming languages, e.g., “C” language or similar programming languages. The computer-readable program instructions may be implemented fully on a user computer, partially on a user computer, as an independent software package, partially on a user computer and partially on a remote computer, or completely on a remote computer or server. In the case where a remote computer is involved, the remote computer may be connected to the user computer via any type of networks, including a local area network (LAN) and a wide area network (WAN), or to an external computer (e.g., connected via Internet using the Internet service provider). In some embodiments, state information of the computer-readable program instructions is used to customize an electronic circuit, e.g., a programmable logic circuit, a field programmable gate array (FPGA) or a programmable logic array (PLA). The electronic circuit may execute computer-readable program instructions to implement various aspects of the present disclosure.

Flowcharts and/or block diagrams of a device, a method and a computer program product in accordance with embodiments of the present disclosure describe various aspects of the present disclosure. It should be appreciated that each block in the block diagrams and/or flowcharts and the combination thereof may be implemented by computer-readable program instructions.

Respective embodiments of the present disclosure have been described for the purpose of illustration, but the present disclosure is not limited to the disclosed embodiments. Without deviating from the essence of the present disclosure, all modifications and transformations fall within the protection scope of the present disclosure defined by the claims.

I/We claim:

1. A method, comprising:
creating, by a system comprising a processor, at least one index segment for a stored stream; and
creating, for an event in the stream, an index file in one of the at least one index segment, to map to the event.

2. The method of claim 1, wherein the stream comprises a plurality of segments, and the creating the at least one index segment comprises:
creating a plurality of index segments for the plurality of segments in the stream.

3. The method of claim 2, wherein each of the plurality of index segments is mapped to a respective segment of the plurality of segments in the stream.

4. The method of claim 2, wherein the event in the stream is included in one of the plurality of segments in the stream, and the creating the index file comprises:
determining, from the plurality of index segments, an index segment mapped to the one of the plurality of segments in the stream.

5. The method of claim 4, wherein the creating the index file further comprises:
creating the index file in the determined index segment, to map to the event

6. The method of claim 1, further comprising:
in response to a new event being appended into the stream, adding a new index file into one of the at least one index segment, to map to the new event.

7. The method of claim 1, wherein the stream comprises at least one of: a metadata stream, a deleted file stream and a data stream.

8. A device for creating an index for stream storage, comprising:
a processor, and
a memory having computer-executable instructions stored thereon which, when executed by the processor, causing the device to perform actions comprising:
creating at least one index segment for a stored stream; and
creating, for an event in the stream, an index file in one of the at least one index segment, to map to the event.

9. The device for claim 8, wherein the stream comprises a plurality of segments, and the creating the at least one index segment comprises:
creating a plurality of index segments for the plurality of segments in the stream, wherein each of the plurality of index segments is mapped to a respective segment of the plurality of segments in the stream.

10. The device for claim 9, wherein the event in the stream is included in one of the plurality of segments in the stream, and the creating the index file comprises:
determining, from the plurality of index segments, an index segment mapped to the one of the plurality of segments in the stream; and
creating the index file in the determined index segment, to map to the event.

11. The device for claim 8, wherein the actions further comprise:
in response to a new event being appended into the stream, adding a new index file into one of the at least one index segment, to map to the new event.

12. The device for claim 8, wherein the stream comprises a metadata stream.

13. The device for claim 8, wherein the stream comprises a deleted file stream.

14. The device for claim 8, wherein the stream comprises a data stream.

15. A computer program product tangibly stored on a non-transitory computer-readable medium and comprising machine-executable instructions, the machine-executable instructions, when executed, causing a machine to perform actions comprising:
creating at least one index segment for a stored stream; and
creating, for an event in the stream, an index file in one of the at least one index segment, to map to the event.

16. The computer program product of claim 15, wherein the stream comprises a segments, and creating the at least one index segment comprises:
creating index segments for the segments in the stream, wherein each of the index segments is mapped to a respective segment of the segments in the stream.

17. The computer program product of claim 16, wherein the event in the stream is included in one of the segments in the stream, and creating the index file comprises:
determining, from the index segments, an index segment mapped to the one of the segments in the stream.

18. The computer program product of claim 17, wherein the creating the index file further comprises:
creating the index file in the determined index segment, to map to the event.

19. The computer program product of claim 15, wherein the actions further comprise:
in response to a new event being appended into the stream, adding a new index file into one of the at least one index segment, to map to the new event.

20. The computer program product of claim 15, wherein the stream comprises at least one of: a metadata stream, a deleted file stream or a data stream.
